(19) United States
(12) Patent Application Publication
(10) Pub. No.: US 2009/0153076 A1
(43) Pub. Date: Jun. 18, 2009

(54) DRIVING CIRCUIT AND METHOD FOR REDUCING OPERATING TEMPERATURE OF LED PACKAGE

(75) Inventors: Chung-Tsai Huang, Taoyuan Hsien (TW); Ching-Chi Cheng, Taoyuan Hsien (TW); Po-Yi Lee, Taoyuan Hsien (TW); Shang-Jin Yan, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/036,945

(22) Filed: Feb. 25, 2008

(30) Foreign Application Priority Data
Dec. 14, 2007 (TW) 096147817

(51) Int. Cl. H05B 41/36

(52) U.S. Cl. 315/294

(57) ABSTRACT

The present invention relates to a driving circuit for driving one or multiple LED chip sets. The driving circuit includes a power converting circuit, one or multiple switching elements, and a controller. The power converting circuit is electrically connected to the one or multiple LED chip sets for receiving an input power and converting the input power into a regulated output voltage or current required for illuminating the one or multiple LED chip sets. The one or multiple switching elements electrically connected to the one or multiple LED chip sets. The controller is electrically connected to the switching elements for controlling alternate or combined simultaneous/alternate switching on/off statuses of the one or multiple switching elements, so that the one or multiple LED chip sets emit light in an alternate lighting manner or a combined simultaneous/alternate lighting manner to reduce the operating temperatures of the one or multiple LED chip sets.

### FIELD OF THE INVENTION

The present invention relates to a diving circuit and a driving method, and more particularly to a diving circuit and a driving method for reducing the operating temperature of a LED package.

### BACKGROUND OF THE INVENTION

In recent years, light emitting diodes (LEDs) capable of emitting light with high luminance and high illuminating efficiency have been developed. In comparison with a common incandescent light, a LED has lower power consumption, long service life, and quick response speed. With the maturity of the LED technology, LEDs will replace all conventional lighting facilities. Until now, LEDs are widely used in many aspects of daily lives, such as automobile lighting devices, handheld lighting devices, backlight sources for LCDs, traffic lights, indicator board displays, and the like.

For most LED packages, there are two mechanisms for dissipating heat, i.e. an internal heat-dissipation mechanism and an external heat-dissipation mechanism. The internal heat-dissipation mechanism uses a thermal conductive body inside the LED package to remove the heat generated from the LED chip to the ambient surroundings. The external heat-dissipation mechanism uses a heat sink or a fan outside the LED package to facilitate heat radiation.

Referring to FIG. 1, a conventional LED package having an internal heat-dissipation mechanism and an external heat-dissipation mechanism is schematically illustrated. The conventional LED package 10 principally includes a LED chip 101, a first substrate 102, a thermal conductive body 103, an encapsulant layer 105, a substrate conductor 106 and an insulating layer 107. A first electrical conductive part 102a and a second electrical conductive part 102b are formed on the first substrate 102 and electrically connected to the anode and the cathode (not shown) of the LED chip 101, respectively. The bottom surface of the first substrate 102 is contacted with the thermal conductive body 103, so that the heat generated from the LED chip 101 and the first substrate 102 are conducted away through the thermal conductive body 103. The first electrical conductive part 102a and the second electrical conductive part 102b are electrically connected with a corresponding substrate conductor 106. The LED chip 101, the first substrate 102 and the thermal conductive body 103 are encapsulated with the encapsulant layer 105 to avoid physical damage or corrosion.

The LED package 10 further includes a second substrate 104. An anode conductive part 104a and a cathode conductive part 104b are formed on the second substrate 104. Via the substrate conductor 106, the first electrical conductive part 102a and the second electrical conductive part 102b are electrically connected with the anode conductive part 104a and the cathode conductive part 104b of the second substrate 104, respectively.

In practical application, the LED package 10 is formed on a printed circuit board 11. An electrical conductive layer 111 is formed on the printed circuit board 11. The anode conductive part 104a and the cathode conductive part 104b of the second substrate 104 are contacted with the electrical conductive layer 111 of the printed circuit board 11, so that the electricity may be transmitted from the printed circuit board 11 to the LED chip 101 of the LED package 10 to illuminate light. The heat generated from the LED package 10 during operation will be transmitted to the outside of the LED package 10 through the thermal conductive body 103. For facilitating heat radiation, a first heat sink 12 and a second heat sink 13 are arranged outside the LED package 10. Generally, the first heat sink 12 and the second heat sink 13 may be directly or indirectly contacted with or connected to the thermal conductive body 103 of the LED package 10. As a consequence, the first heat sink 12 and a second heat sink 13 may facilitate dissipating heat to the ambient surroundings in a passive manner. In addition to the heat sink, an air flow generating device such as a fan may be used to facilitate dissipating heat to the ambient surroundings in an active manner.

Since a great amount of heat is generated from the LED chip 101, the internal heat-dissipation mechanism of using the thermal conductive body 103 and/or the external heat-dissipation mechanism of using the heat sinks 12 and 13 are usually insufficient to dissipate away the heat. If the heat generated from the LED chip is not effectively dissipated away, the higher operating temperature may degrade the performance of the LED package or eventually leads to device failure. Moreover, the external heat-dissipation mechanism is not cost-effective. If the air flow generating device has a breakdown, the operating temperature of the LED chip is abruptly increased.

There is a need of providing a diving circuit and a driving method for reducing the operating temperature of a LED package to obviate the drawbacks encountered from the prior art.

### SUMMARY OF THE INVENTION

It is an object of the present invention to provide a diving circuit and a driving method for reducing the operating temperature of a LED package in order to avoid the problems encountered from the conventional heat-dissipation mechanisms.

In accordance with an aspect of the present invention, there is provided a driving circuit for driving one or multiple LED chip sets. The driving circuit includes a power converting circuit, one or multiple switching elements, and a controller. The power converting circuit is electrically connected to the one or multiple LED chip sets for receiving an input power and converting the input power into a regulated output voltage or current required for illuminating the one or multiple LED chip sets. The one or multiple switching elements electrically connected to the one or multiple LED chip sets. The controller is electrically connected to the switching elements for controlling alternate or combined simultaneous/alternate switching on/off statuses of the one or multiple switching elements, so that the one or multiple LED chip sets emit light in an alternate lighting manner or a combined simultaneous/alternate lighting manner to reduce the operating temperatures of the one or multiple LED chip sets.

In accordance with another aspect of the present invention, there is provided a driving circuit for driving one or multiple LED chip sets. The driving circuit includes a power converting circuit and a waveform generator. The power converting circuit is used for receiving an input power and converting the input power into a regulated output voltage or current required for illuminating the one or multiple LED chip sets. The waveform generator is electrically connected to the power converting circuit and the one or multiple LED chip sets for generating a control wave with positive and negative voltages, wherein the one or multiple LED chip sets in an alternate lighting manner in response to the positive and negative voltages of the control wave.

In accordance with another aspect of the present invention, there is provided a method of reducing the operating temperature of a LED package including one or multiple LED chip sets. First of all, a driving circuit is provided and electrically connected with the one or multiple LED chip sets. By the driving circuit, the one or multiple LED chip sets are driven and controlled to emit light in the alternate lighting manner or a combined simultaneous/alternate lighting manner so as to reduce the operating temperatures of the one or multiple LED chip sets.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional LED package;

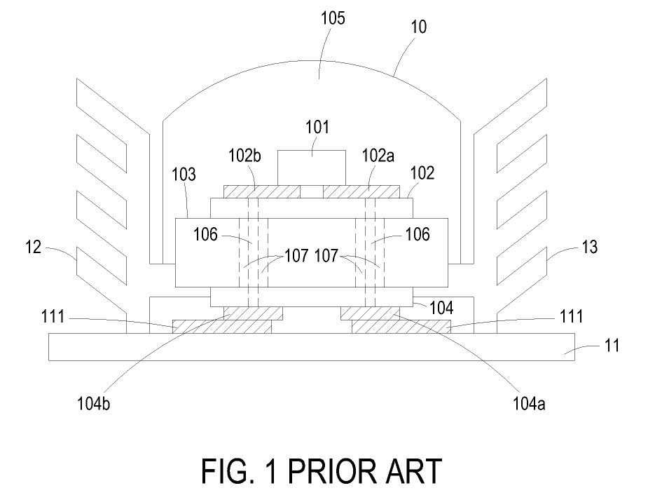

FIG. 2 is a circuit diagram illustrating a driving circuit according to a preferred embodiment of the present invention;

FIG. 3 is a circuit diagram illustrating a driving circuit according to another preferred embodiment of the present invention;

FIG. 4 is a characteristic plot showing the brightness and the operating temperature of a single LED chip as a function of operating time;

FIG. 5 is a graph showing the relationship between the brightness and the operating temperature of the first LED chip set and the second LED chip set as a function of operating time by an alternate lighting manner;

FIG. 6 is a timing diagram illustrating on/off statuses of the first switching element and the second switching element by a combined simultaneous/alternate lighting manner; and

FIG. 7 is a schematic view illustrating a LED package with a reduced operating temperature according to another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

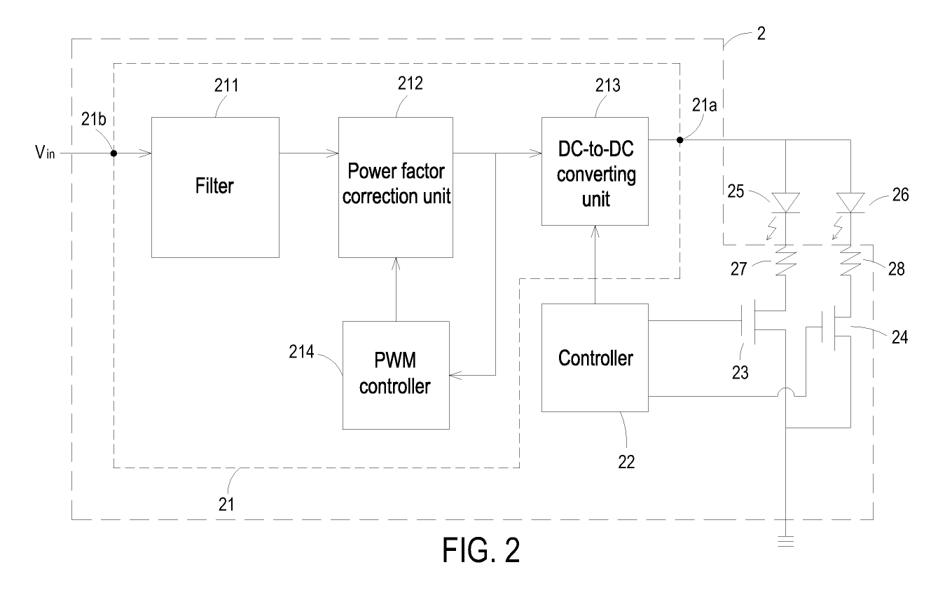

FIG. 2 is a circuit diagram illustrating an exemplary driving circuit according to a preferred embodiment of the present invention. The driving circuit 2 is used to drive a plurality of LED chips. These LED chips are divided into a first LED chip set 25 and a second LED chip set 26. The driving circuit 2 principally includes a power converting circuit 21, a controller 22, a first switching element 23 and a second switching element 24. An output terminal 21a of the power converting circuit 21 is coupled to the first LED chip set 25 and the second LED chip set 26. By the power converting circuit 21, the input power Vᵢₙ is received and converted into a regulated output voltage or current required for the first LED chip set 25 and the second LED chip set 26. In a case that the input power Vᵢₙ is alternating current, the power converting circuit 21 is a DC-to-DC converter for converting the input power Vᵢₙ into direct current required for the first LED chip set 25 and the second LED chip set 26. The controller 22 is electrically connected to the power converting circuit 21, the first switching element 23 and the second switching element 24 for controlling on/off statuses of the first switching element 23 and the second switching element 24. In some embodiments, the controller 22 may control the magnitude of the voltage or current outputted from the power converting circuit 21 so as to adjust the brightness of the emitted light from the first LED chip set 25 and the second LED chip set 26. The first switching element 23 is connected in series with the first LED chip set 25 and the output terminal 21a of the power converting circuit 21. The second switching element 24 is connected in series with the second LED chip set 26 and the output terminal 21a of the power converting circuit 21.

In some embodiments, the driving circuit 2 further includes a first impedance element 27 (e.g. a first resistor) and a second impedance element 28 (e.g. a second resistor). The first impedance element 27 is connected in series with the first LED chip set 25. The second impedance element 28 is connected in series with the second LED chip set 26. By means of the first impedance element 27 and the second impedance element 28, the problem of causing instable brightness of emitted light due to temperature variations is alleviated.

In some embodiments, the power converting circuit 21 includes a filter 211, a power factor correction unit 212, a DC-to-DC converting unit 213 and a pulse width modulation (PWM) controller 214. The filtering unit 211 is interconnected between the input terminal 21b of the power converting circuit 21 and the power factor correction unit 212 for filtering the input power Vᵢₙ. The power factor correction unit 212 is interconnected between the filtering unit 211 and the DC-to-DC converting unit 213 for correcting the power factor of the power converting circuit 21 and converting the alternating voltage of the input power Vᵢₙ into a DC voltage, which is transmitted to the DC-to-DC converting unit 213. The DC-to-DC converting unit 213 is interconnected between the power factor correction unit 212 and the output terminal 21a of the power converting circuit 21 for converting the DC voltage into a regulated output voltage or current required for illuminating the first LED chip set 25 and the second LED chip set 26. The PWM controller 214 is interconnected between the power factor correction unit 212 and the DC-to-DC converting unit 213 for controlling operations of the power factor correction unit 212.

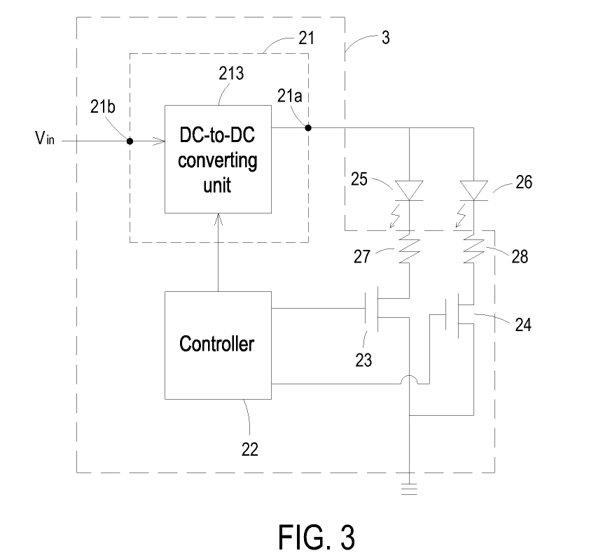

A further embodiment of a driving circuit 3 is illustrated in FIG. 3. In this embodiment, the input power Vin is a DC voltage and the power converting circuit 21 includes the DC-to-DC converting unit 213. The DC voltage of the input power Vᵢₙ is received and converted into a regulated output voltage or current required for illuminating the first LED chip set 25 and the second LED chip set 26.

In some embodiments, the first LED chip set 25 and the second LED chip set 26 included in the driving circuit 2 or 3 may be packaged as a single LED package or formed as individual LED packages according to the conventional packaging technology. Each of the first LED chip set 25 and the second LED chip set 26 includes at least one LED chip. For clarification, each of the first LED chip set 25 and the second LED chip set 26 with one LED chip is illustrated as follows.

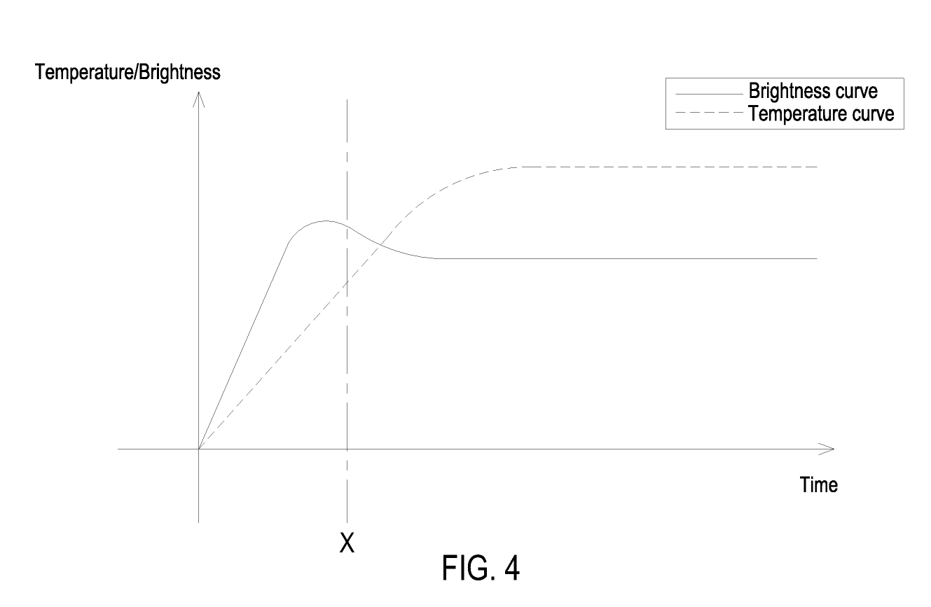

FIG. 4 is a characteristic plot showing the brightness and the operating temperature of a single LED chip as a function of operating time. As shown in the dotted curve of FIG. 4, the operating temperature of the LED chip is substantially in direct proportion to the operating time in the early stage. By an external heat-dissipation mechanism for example fan, the operating temperature of the LED chip is then maintained at an elevated temperature. On the other hand, the LED brightness reaches its maximum value in a shorter time period and is then slightly reduced to a specified value, as is indicated by the solid curve. In accordance with a key feature of the present invention, one or multiple LED chip sets emit light in an alternate lighting manner in order to reduce the operating time. As the operating time is reduced, the junction temperature of individual LED chips is lowered and thus the brightness of the light emitted from the overall LED package maintains at a desired level. For example, after the first LED chip set illuminates for a certain time period X (e.g. 10 ms), the first LED chip set is disabled while another LED chip set (e.g. the second LED chip set) is enabled to emit light. According to such an alternate lighting manner, the operating time of individual LED chips is reduced, the junction temperature of individual LED chips is lowered and the brightness of the light emitted from the overall LED package maintains at a desired level.

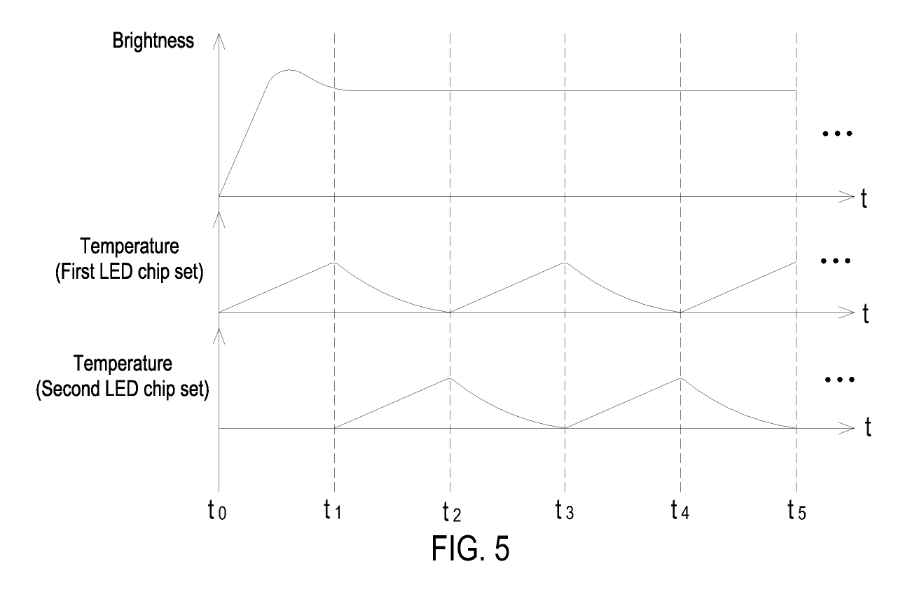

FIG. 5 is a graph showing the relationship between the brightness and the operating temperature of the first LED chip set and the second LED chip set as a function of operating time. The operation principles of the alternate lighting manner will be described in more details as follows with reference to FIGS. 2, 3 and 5.

At t=t₀, the driving circuit 2 is activated, and the controller 22 issues an enabling signal (e.g. a high-level voltage) to the first switching element 23. In response to the enabling signal, the first switching element 23 is turned on and thus the power converting circuit 21 transmits electricity to the first LED chip set 25 to illuminate the first LED chip set 25. As the operating time elapses, the LED brightness gradually reaches to its maximum value and is then slightly reduced to a specified value. In the stage from t=t₀ to t=t₁, the operating temperature of the LED chip is substantially in direct proportion to the operating time. In other words, the operating temperature of the first LED chip set 25 is increased as the operating time is increased.

At t=t₁, the controller 22 issues an enabling signal to the second switching element 24 while issuing a disenabling signal (e.g. a low-level voltage) to the first switching element 23. In response to the enabling signal, the second switching element 24 is turned on and thus the power converting circuit 21 transmits electricity to the second LED chip set 26 to illuminate the second LED chip set 26. Whereas, in response to the disenabling signal, the first switching element 23 is turned off to interrupt the illumination of the first LED chip set 25. In the stage from t=t₁ to t=t₂, the brightness of the first LED chip set 25 is gradually decreased but the brightness of the second LED chip set 26 is gradually increased to be close to its maximum value. As a consequence, the brightness of the light emitted from the overall LED package maintains at a desired level of nearly the maximum value. Moreover, in the stage from t=t₁ to t=t₂, the operating temperature of the second LED chip set 26 is gradually increased but the operating temperature of the first LED chip set 25 is gradually decreased. As a consequence, the operating temperature of the overall LED package maintains at an acceptable level.

Similarly, in the stage from t=t₂ to t=t₃, the first LED chip set 25 is controlled by the controller 22 to emit light but the illumination of the second LED chip set 26 is interrupted. In the stage from t=t₃ to t=t₄, the first LED chip set 25 is controlled by the controller 22 to interrupt illumination but the second LED chip set 26 is controlled to emit light. In the stage from t=t₄ to t=t₅, the first LED chip set 25 is controlled by the controller 22 to emit light but the illumination of the second LED chip set 26 is interrupted. The rest may be deduced by analog. Accordingly, by alternately lighting the first LED chip set 25 and the second LED chip set 26, the brightness of the light emitted from the overall LED package maintains at a desired level, which is substantially equal to the brightness of the light emitted from a single LED chip set. More especially, the operating temperature of the overall LED package may be reduced to approximately a half of the operating temperature of a single LED chip set. In some embodiments, at least two LED chip sets are packaged as the LED package, and the size of the overall LED package is considerably reduced when compared with the conventional LED package. Since the operating temperature of the overall LED package is largely reduced by the driving circuit of the present invention, the cost associated with heat dissipation is reduced.

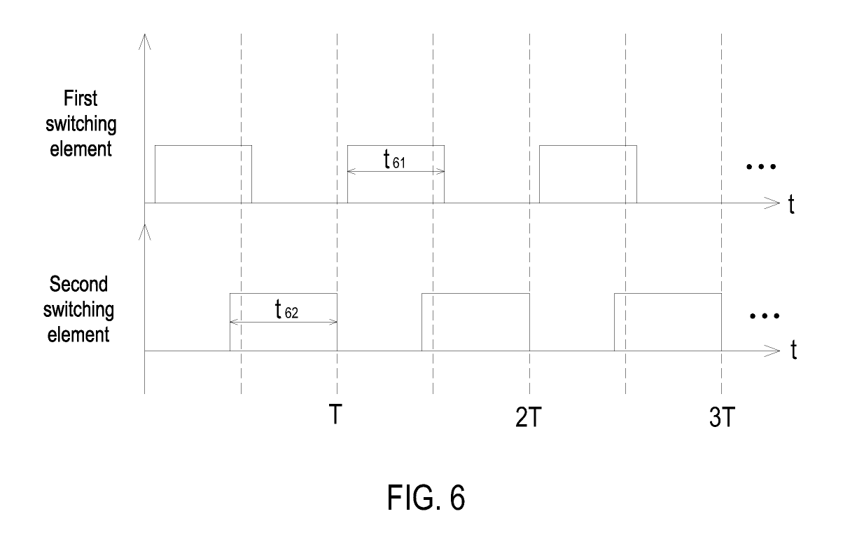

In the above embodiments, the first switching element 23 and the second switching element 24 are controlled by the controller 22 to be alternatively turned on or turned off, so that the first LED chip set 25 and the second LED chip set 26 can emit light in an alternate lighting manner. It is noted that, however, those skilled in the art will readily observe that numerous modifications and alterations of the lighting manner may be made while retaining the teachings of the invention. For example, the on/off statuses of the first switching element 23 and the second switching element 24 may be partially overlapped with each other, as can be seen in FIG. 6. For each cycle period T, the on duration of the first switching element 53 is t₆₁ and the on duration of the second switching element 54 is t₆₂. In some time intervals, the on/off statuses of the first switching element 23 and the second switching element 24 are partially overlapped with each other. Whereas, in the remaining time intervals, the first switching element 23 and the second switching element 24 are alternatively turned on or turned off, so that the first LED chip set 25 and the second LED chip set 26 can emit light in an alternate lighting manner. Moreover, the first LED chip set 25 is operated at a duty cycle of t₆₁/T and the second LED chip set 26 is operated at a duty cycle of t₆₂/T. Alternatively, the duty cycles of the first LED chip set 25 and the second LED chip set 26 may be identical or different according to the performance requirements. In the context of the present invention, the lighting manner as shown in FIG. 6 is also referred as a combined simultaneous/alternate lighting manner.

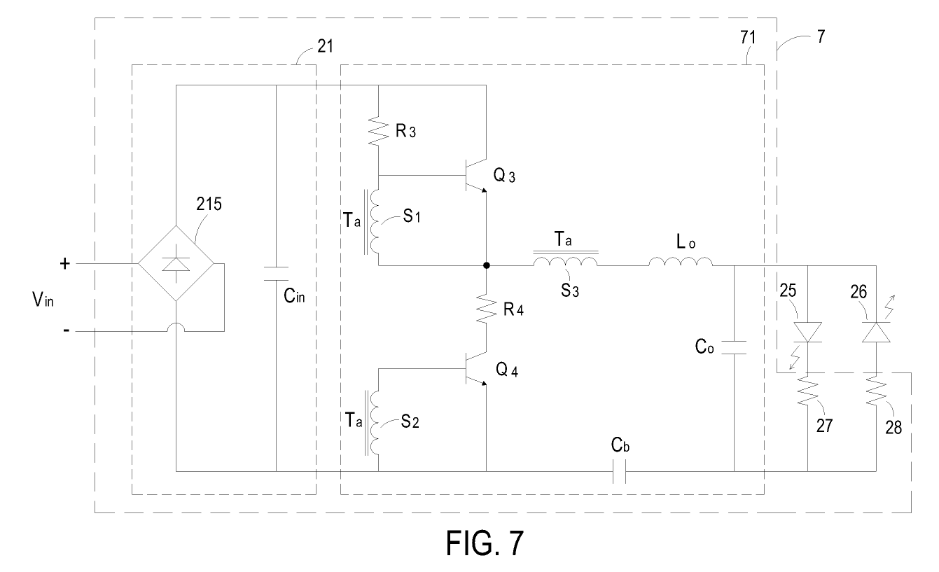

In the above embodiments, the driving circuit is implemented in a digital form. Nevertheless, the driving circuit of the present invention may be implemented in an analog form. FIG. 7 is a circuit diagram illustrating an exemplary driving circuit implemented in an analog form. The driving circuit 7 includes a power converting circuit 21 and a waveform generator 71. The power converting circuit 21 is electrically connected to the waveform generator 71. After the input power Vᵢₙ is received by the power converting circuit 21, the input power Vᵢₙ is converted and transmitted to the waveform generator 71. The output terminal of the waveform generator 71 is connected to the first LED chip set 25 and the second LED chip set 26. By the waveform generator 71, a control wave with positive and negative voltages is generated. An example of the control wave includes but is not limited to a rectangular wave, a square wave and the like. The positive and negative voltages of the control wave are used to drive the first LED chip set 25 and the second LED chip set 26, respectively.

In this embodiment, the directions of the current passing through the first LED chip set 25 and the second LED chip set 26 are opposed to each other. During a certain interval, only one of the first LED chip set 25 and the second LED chip set 26 is turned on to emit light. For example, the first LED chip set 25 is turned on to emit light in response to the positive voltage of the control wave outputted from the waveform generator 71, but the second LED chip set 26 is turned on to emit light in response to the negative voltage of the control wave outputted from the waveform generator 71. As the control wave with positive and negative voltages is continuously generated from the waveform generator 71, the first LED chip set 25 and the second LED chip set 26 emit light in an alternate lighting manner. In some embodiments, a transient zero voltage is intervened between the positive and negative voltages. During the time interval corresponding to the zero voltage, the first LED chip set 25 and the second LED chip set 26 both interrupt illumination. In some embodiments, the durations of the positive voltage and the negative voltage may be identical or varied according to the performance requirement of respective LED chip sets.

In some embodiments, the driving circuit 7 further includes a first impedance element 27 (e.g. a first resistor) and a second impedance element 28 (e.g. a second resistor). The first impedance element 27 is connected in series with the first LED chip set 25. The second impedance element 28 is connected in series with the second LED chip set 26. By means of the first impedance element 27 and the second impedance element 28, the problem of causing instable brightness of emitted light due to temperature variations is alleviated.

Please refer to FIG. 7 again. The power converting circuit 21 includes a rectifier 215 and an input capacitor Cᵢₙ. The input power Vᵢₙ is rectified into DC power by the rectifier 215. The noise contained in the DC power is filtered off by the input capacitor Cᵢₙ, thereby generating a suitable voltage or current required for the waveform generator 71.

Furthermore, the waveform generator 71 includes a third switching element Q₃, a fourth switching element Q₄, a transformer Ta, a third resistor R₃, a fourth resistor R₄, an output inductor Lₒ, an output capacitor Cₒ and a second capacitor C_{b}. The emitter of the third switching element Q₃ is coupled to the fourth resistor R₄, the first winding coil S₁ and the third winding coil S₃ of the transformer Tₐ. The base of the third switching element Q₃ is coupled to the third resistor R₃ and the first winding coil S₁ of the transformer Tₐ. The collector of the third switching element Q₃ is coupled to the positive end of the power converting circuit 21. The emitter of the fourth switching element Q₄ is coupled to the negative end of the power converting circuit 21. The base of the fourth switching element Q₄ is coupled to the second winding coil S₂ of the transformer Tₐ. The collector of the fourth switching element Q₄ is coupled to the fourth resistor R₄. The output capacitor Cₒ is coupled to the output terminal of the waveform generator 71 and connected in series with the output inductor Lₒ, the second capacitor C_{b} and the third winding coil S₃ of the transformer Tₐ.

In this embodiment, when the third switching element Q₃ is turned on but the fourth switching element Q₄ is turned off, a close loop is defined by the third switching element Q₃, the third winding coil S₃ of the transformer Tₐ, the output inductor Lₒ, the output capacitor Cₒ and the second capacitor C_{b}, so that a positive voltage is outputted from the waveform generator 71 to illuminate the first LED chip set 25. Whereas, when the third switching element Q₃ is turned off but the fourth switching element Q₄ is turned on, a close loop is defined by the fourth switching element Q₄, the third winding coil S₃ of the transformer Tₐ, the output inductor Lₒ, the output capacitor Cₒ and the second capacitor C_{b}, so that a negative voltage is outputted from the waveform generator 71 to illuminate the second LED chip set 26. Accordingly, the first LED chip set 25 and the second LED chip set 26 emit light in an alternate lighting manner, thereby decreasing the operating temperature of the overall LED package.

From the above description, by using the driving circuit and the driving method of the present invention, one or multiple LED chip sets emit light in an alternate lighting manner or in a combined simultaneous/alternate lighting manner in order to reduce the operating time. According to an alternate lighting manner or the combined simultaneous/alternate lighting manner, the operating time of individual LED chips is reduced and the junction temperature of individual LED chips is lowered. As a consequence, the illuminating efficiency of the overall LED package is increased and the brightness of the light emitted from the overall LED package maintains at a desired level. Since the problems encountered from the conventional heat-dissipation mechanisms are overcome, the LED package of the present invention is advantageous in the aspects of heat-dissipating efficiency and cost-effectiveness.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A driving circuit for driving one or multiple LED chip sets, said driving circuit comprising:
a power converting circuit electrically connected to said one or multiple LED chip sets for receiving an input power and converting said input power into a regulated output voltage or current required for illuminating said one or multiple LED chip sets;
one or multiple switching elements electrically connected to said one or multiple LED chip sets; and
a controller electrically connected to said switching elements for controlling alternate or combined simultaneous/alternate switching on/off statuses of said one or multiple switching elements, so that said one or multiple LED chip sets emit light in an alternate lighting manner or a combined simultaneous/alternate lighting manner to reduce the operating temperatures of said one or multiple LED chip sets.

2. The driving circuit according to claim 1 wherein said one or multiple LED chip sets are packaged as a single LED package.

3. The driving circuit according to claim 1 wherein said one or multiple LED chip sets are packaged as individual LED packages.

4. The driving circuit according to claim 1 wherein each of said one or multiple LED chip sets includes at least one LED chip.

5. The driving circuit according to claim 1 wherein said multiple LED chip sets includes at least a first LED chip set and a second LED chip sets, and said driving circuit further includes:
a first switching element electrically connected to said first LED chip set and said power converting circuit; and
a second switching element electrically connected to said second LED chip set and said power converting circuit.

6. The driving circuit according to claim 5 wherein said first switching element and said second switching element controlled by said controller have identical or different duty cycles.

7. The driving circuit according to claim 5 wherein said driving circuit further includes:
a first impedance element connected in series with said first LED chip set; and
a second impedance element connected in series with said second LED chip set.

8. The driving circuit according to claim 5 wherein said power converting circuit includes:
a filter electrically connected to an input terminal of said power converting circuit for filtering said input power;
a power factor correction unit electrically connected to said filter for correcting the power factor of said power converting circuit and converting said input power;
a DC-to-DC converting unit interconnected between said power factor correction unit and an output terminal of said power converting circuit for converting said corrected input power into said regulated output voltage or current required for illuminating said first LED chip set and said second LED chip set; and
a pulse width modulation controller interconnected between said power factor correction unit and said DC-to-DC converting unit for controlling operations of said power factor correction unit.

9. The driving circuit according to claim 5 wherein said power converting circuit includes a DC-to-DC converting unit for directly receiving said input power and converting said input power into said regulated output voltage or current required for illuminating said first LED chip set and said second LED chip set.

10. A driving circuit for driving one or multiple LED chip sets, said driving circuit comprising:
a power converting circuit for receiving an input power and converting said input power into a regulated output voltage or current required for illuminating said one or multiple LED chip sets; and
a waveform generator electrically connected to said power converting circuit and said one or multiple LED chip sets for generating a control wave with positive and negative voltages, wherein said one or multiple LED chip sets in an alternate lighting manner in response to said positive and negative voltages of said control wave.

11. The driving circuit according to claim 10 wherein said multiple LED chip sets includes at least a first LED chip set and a second LED chip sets, wherein the direction of the current passing through said first LED chip set is opposed to the direction of the current passing through said second LED chip set.

12. The driving circuit according to claim 11 wherein said control wave is continuously generated from said waveform generator.

13. The driving circuit according to claim 11 wherein said driving circuit further includes:
a first impedance element connected in series with said first LED chip set; and
a second impedance element connected in series with said second LED chip set.

14. The driving circuit according to claim 11 wherein said power converting circuit includes:
a rectifier for rectifying said input power; and
an input capacitor for filtering off noise and generating a voltage or current required for said waveform generator.

15. The driving circuit according to claim 11 wherein said waveform generator includes a plurality of switching elements, which are alternatively conducted or shut off, so that said first LED chip set and said second LED chip set emit light in said alternate lighting manner.

16. A method of reducing the operating temperature of a LED package including one or multiple LED chip sets, said method comprising steps of:
providing a driving circuit and electrically connecting said driving circuit with said one or multiple LED chip sets; and
driving and controlling said one or multiple LED chip sets by said driving circuit to emit light in said alternate lighting manner or a combined simultaneous/alternate lighting manner so as to reduce the operating temperatures of said one or multiple LED chip sets.

17. The method according to claim 16 wherein said driving circuit includes:
a power converting circuit electrically connected to said one or multiple LED chip sets for receiving an input power and converting said input power into a regulated output voltage or current required for illuminating said one or multiple LED chip sets;
one or multiple switching elements electrically connected to said one or multiple LED chip sets; and
a controller electrically connected to said switching elements for controlling alternate or combined simultaneous/alternate switching on/off statuses of said one or multiple switching elements, so that said one or multiple LED chip sets emit light in said alternate lighting manner or said combined simultaneous/alternate lighting manner to reduce the operating temperatures of said one or multiple LED chip sets.

18. The method according to claim 16 wherein said driving circuit includes:
a power converting circuit for receiving an input power and converting said input power into a regulated output voltage or current required for illuminating said one or multiple LED chip sets; and
a waveform generator electrically connected to said power converting circuit and said one or multiple LED chip sets for generating a control wave with positive and negative voltages, wherein said one or multiple LED chip sets in an alternate lighting manner in response to said positive and negative voltages of said control wave.
